(19) United States
(12) Patent Application Publication
(10) Pub. No.: US 2002/0158132 A1
(43) Pub. Date: Oct. 31, 2002

(54) Filter for barcode scanner

(76) Inventor: Yu-Chun Chang, Taipei (TW)

Correspondence Address: BACON & THOMAS, PLLC, 4th Floor, 625 Slaters Lane, Alexandria, VA, 22314-1176, US

(21) Appl. No.: 09/842,715

(22) Filed: Apr. 27, 2001

(51) Int. Cl. G02B 5/08; G06K 7/10; G02B 26/00

(52) U.S. Cl. 235/462.35

(57) ABSTRACT

An improved filter for barcode scanner comprises: a glass layer, a first filter layer plated on an outer surface of the glass layer and a second filter layer plated on an inner surface of the glass layer. When the barcode image light of an object reflects to the first filter layer, the first filter layer will filter out successively the mixed light contained in the image light, and allows only red light to pass through the glass layer. Then the red light enters the second filter layer which filters out again successively the residual mixed light escaped from the first filter layer and results in a pure red light to enter the front end apparatus for the sensor means in the front end apparatus to read accurately.

### BACKGROUND OF THE INVENTION

This invention relates to an improved filter for barcode scanner and particularly a filter that has double filtering effect for filtering barcode image light reflecting from a barcode of an object.

The commonly known barcode scanners at present usually comprise: a front end apparatus and a back end apparatus for scanning and reading a barcode disposed on an object. The front end apparatus generally consists of: a scan means, a light source unit, a filter means and a sensor means. The light source unit projects light on the scan means which then directs the light to the barcode of the object. The image light reflected from the barcode passes through the filter means to the sensor means which converts the light to an electric signal output. The back end apparatus has circuits for processing the electric signal output from the sensor means to recognize the object being scanned.

When the barcode scanner scans the barcode, the scan means, light source unit and sensor means of the front end apparatus and the circuits of the back end apparatus can easily control the scanning accuracy, however the filter means has difficulty to control the filtering of the image light. This is because the filter means not only filter the image light reflecting from the barcode, it also has to filter the mixed light generated in the ambience. If the mixed light of the ambience has not been filtered completely and thoroughly, it could result in not accurate reading or wrong judgement of the scanner, or even not readable.

To remedy the foregoing problems, some manufacturers have introduced a number of filter means designs. FIG. 1 shows the first filter means which has a red acrylic 1A and a filter lens 2A attached to the sensor means 3A. The red acrylic 1A allows only red light to pass through, and the filter lens filters out the mixed light contained in the red light before the light being received by the sensor means 3A.

In the second filter means (shown in FIG. 2), there are a red acrylic 1B and a filter lens 2B attached to the red acrylic 1B. The red acrylic 1B allows only red light to pass through, and the filter lens 2B filters out the mixed light contained in the red light before the light being received by the sensor means 3B.

The third filter means (shown in FIG. 3) includes a red acrylic 1C which has an inner surface plated with a filter layer 2C which consists multiple layers of film and a filter lens 3C attached to the sensor means 4C. The red acrylic IC allows only red light to pass through, the filter layer 2C filters out successively the mixed light contained in the red light, then the filter lens 3C filters the light one more time before the light being received by the sensor means 4C.

All the three filter means set forth above still cannot effectively filter out all the mixed light contained in the image light reflected from the barcode of the object. There is residual mixed light trapped in the front end apparatus and may result in not accurate reading, not able reading, or wrong reading of the barcode. Furthermore, the foregoing three types of construction are quite difficult to fabricate and will result in increased production cost.

### SUMMARY OF THE INVENTION

The primary object of this invention is to resolve aforesaid disadvantages by providing an improved filter means that has an inner and an outer surface plated respectively with a filter layer which is capable of filtering light successively layer by layer. Only red light reflecting from the barcode will be allowed to pass through, and the mixed light from the ambience will not enter into the front end apparatus of the scanner, hence there is not impediment to the normal sensing operation of the sensor means.

Another object of this invention is to make fabrication easier and to greatly reduce production cost.

In order to attain aforesaid objects, the filter means according to this invention comprises: a glass layer, a first filter layer plated on the outer surface of the glass layer and a second filter layer plated on the inner surface of the glass layer. When the barcode image light of an object reflects to the first filter layer, the mixed light contained in the image light will be filtered out successively by the first filter layer, and only red light will pass through. Then the light enters the second filter layer which filters out again the residual mixed light escaped from the first filter layer and results in a pure red light to reach the sensor means of the front end apparatus for obtaining accurate reading.

### BRIEF DESCRIPTION OF THE DRAWINGS

The invention, as well as its many advantages, may be further understood by the following detailed description and drawings, in which:

FIG. 1 is a fragmentary schematic view of a conventional filter means for a barcode scanner.

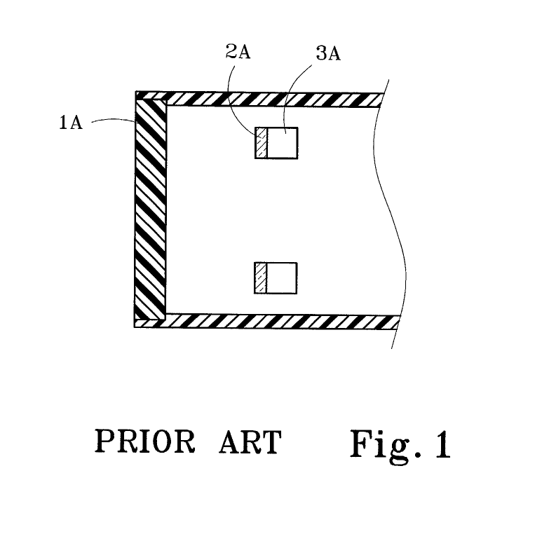

FIG. 2 is a fragmentary schematic view of another conventional filter means for a barcode scanner.

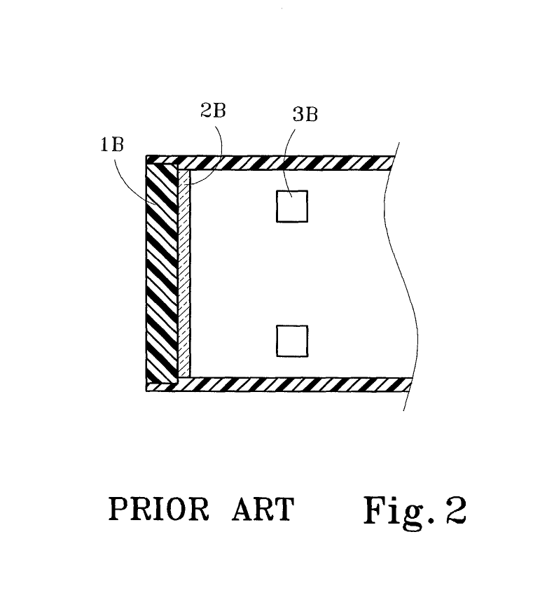

FIG. 3 is a fragmentary schematic view of yet another conventional filter means for a barcode scanner.

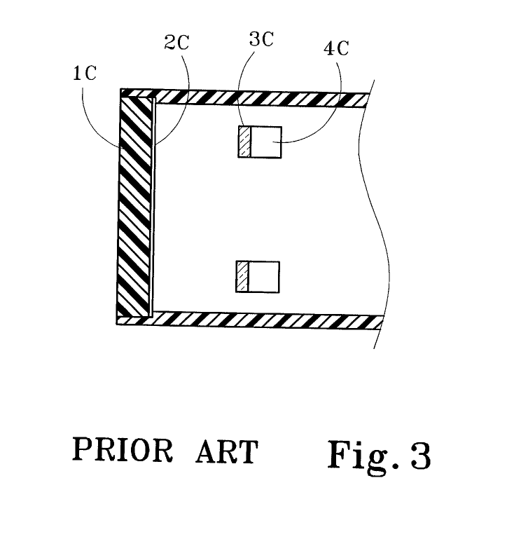

FIG. 4 is a schematic top view of a filter means of this invention.

FIG. 5 is a fragmentary sectional view of a filter means for a barcode scanner of this invention.

### DETAILED DESCRIPTION OF THE PREFERRED EMBODIMENT

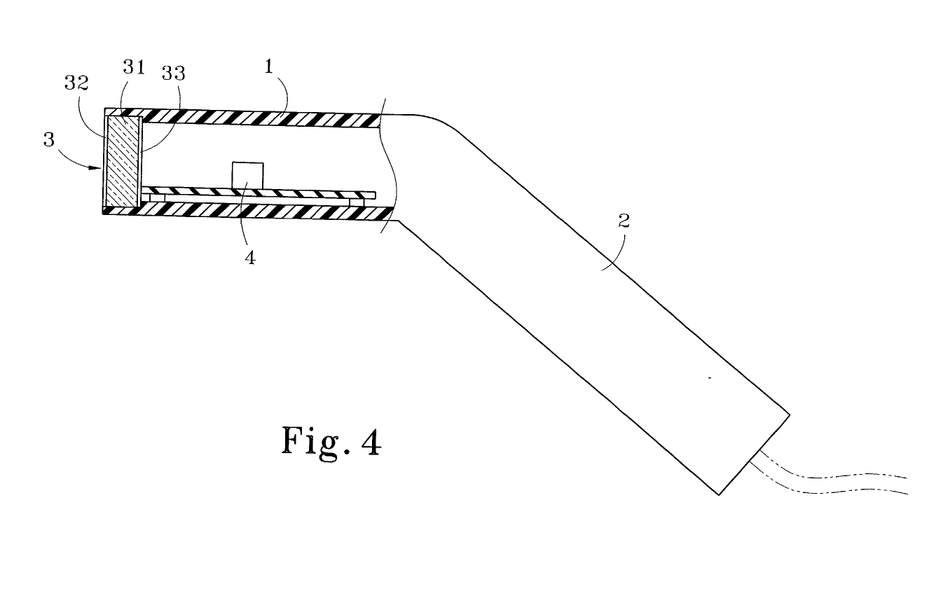

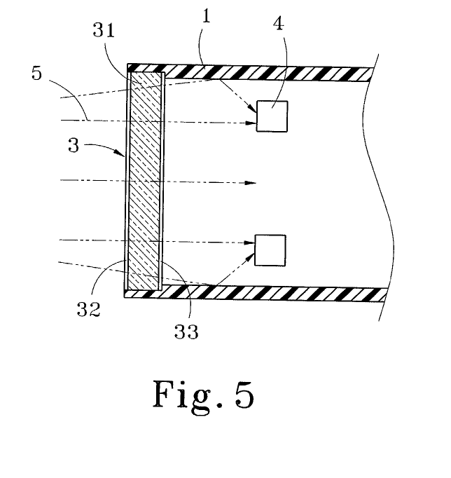

Referring to FIGS. 4 and 5, the filter means of this invention is adapted for a barcode scanner which comprises a front end apparatus 1 and a back end apparatus 2 for reading a barcode on an object (not shown in the drawings).

The front end apparatus 1 generally includes a scan means (not shown in the drawings), a light source unit (not shown in the drawings), a filter means 3 and a sensor means 4. The light source unit projects light on the scan means which then directs the light to the barcode of the object. The barcode reflects an image light 5 which passes through the filter means 3 and enters the sensor means 4 which receives and converts the light to an electric signal output. The back end apparatus has circuits for processing the electric signal output from the sensor means 4 thereby to recognize the object being scanned.

When the barcode scanner scans the barcode, the scan means, light source unit and sensor means 4 of the front end apparatus 1 and the circuits (not shown in the drawings) of the back end apparatus 2 can easily control the scanning accuracy, however the filter means 3 has difficulty to control the filtering of the image light 5. This is because the filter means 3 not only filter the image light 5 reflected from the barcode, it also has to filter the mixed light generated in the ambience. If the mixed light of the ambience has not been filtered completely and thoroughly, it could result in not accurate reading or wrong judgement of the scanner, or even not readable.

Hence in this invention, the filter means 1 has an inner surface and an outer surface plated respectively with a filter layer which is capable of filtering light successively layer by layer. Only the red light 5 reflecting from the barcode will be allowed to pass through, and the mixed light from the ambience will be prevented from entering into the front end apparatus 1 of the scanner, hence there is not impediment to the normal sensing operation of the sensor means 4.

The filter means 3 according to this invention includes: a glass layer 31, a first filter layer 32 plated on an outer surface of the glass layer 31 and a second filter layer 33 plated on an inner surface of the glass layer 31. The glass layer 31 is a glass which has full spectrum characteristics to allow red light 5 (image light reflecting from the barcode) to pass through completely.

The first and second filter layer 32 and 33 are multiple film nature and are plated respectively on the outer and inner surface of the glass layer 31 for successively filtering out the mixed light contained in the red light 5 and allows only the red light 5 to pass through.

When the barcode scanner scans the barcode of an object, the light source unit of the scanner projects light on the scan means which directs the light to the barcode of the object. The barcode then generates image light 5 (red light) and reflects to the filter means 3. The image light 5 passes through the first filter layer 32 which successively filters out the mixed light contained in the image light 5 and allows only the red light to pass through. The red light passing through the first filter layer 32 will pass through the glass layer 31 completely and enters the second filter layer 33. The second filter layer 33 then filters out again the residual mixed light escaped from the first filter layer 32 and results in a pure red light entering into the front end apparatus of the scanner. Hence there is no mixed light in the front end apparatus. Even the red light refracts randomly in the front end apparatus, the sensor means 4 still can sense accurately.

Furthermore, this invention plates filter layers 32 and 33 respectively on the outer and inner surface of the glass layer 31 that are capable of successively filtering image light. Besides to prevent the mixed light from entering into the front end apparatus 1, it is easier to fabricate and may greatly reduce production cost.

What is claimed is:

1. An improved filter for barcode scanner for disposing on a front end apparatus of a scanner to filter barcode image light reflected from a scanning object, comprising:
a glass layer;
a first filter layer plated on an outer surface of the glass layer for filtering the image light reflected from a barcode of the object; and
a second filter layer plated on an inner surface of the glass layer for filtering the not completely filtered image light which has passed through the first filter layer;
wherein the first filter layer filters out successively mixed light contained in the image light reflected from the object barcode and allows only red light to pass through, and the second filter layer filtering out the residual mixed light contained in the red light which has passed through the first filter layer to generate a pure red light for entering into the front end apparatus to enable a sensor means located in the front end apparatus to read accurately.

2. The improved filter of claim 1, wherein the glass layer is a transparent glass.

3. The improved filter of claim 1, wherein the first and second filter layer are respectively a multiple film construction.
